(19) United States
(12) Patent Application Publication
(10) Pub. No.: US 2012/0189106 A1
(43) Pub. Date: Jul. 26, 2012

(54) MOBILE X-RAY UNIT

(76) Inventors: Thamar J.S. VERHAAR, Utrecht (NL); Sander-Willem VAN SCHAIK, Utrecht (NL); Sebastiaan Willem HEKKENBERG, Utrecht (NL)

(21) Appl. No.: 13/335,794

(22) Filed: Dec. 22, 2011

Related U.S. Application Data
(60) Provisional application No. 61/426,937, filed on Dec. 23, 2010.

(30) Foreign Application Priority Data
Dec. 22, 2010 (NL) 2005898

(51) Int. Cl. H05G 1/02

(52) U.S. Cl. 378/198

(57) ABSTRACT

One embodiment of the present disclosure may be directed to a mobile X-ray unit. The mobile X-ray unit may include a base and a mast associated with the base. The mobile X-ray unit may further include an arm having a ball joint and a rotational joint. The arm may rotate relative to the mast about the rotational joint, and a X-ray applicator may rotate relative to the mast about the ball joint.

### CROSS-REFERENCE TO RELATED APPLICATIONS

This application claims the benefit of priority based on U.S. Provisional Patent Application No. 61/426,937, filed Dec. 23, 2010, and Netherlands Patent Application No. 2005898, filed Dec. 22, 2010, which are all incorporated herein by reference.

### FIELD OF THE INVENTION

The present disclosure relates generally to a mobile X-ray unit. The present disclosure also relates to a method of manufacturing the mobile X-ray unit.

### BACKGROUND OF THE INVENTION

The incidence rate of skin cancer has substantially increased in the last decade of the 20^{th} century. It is appreciated that over 1.3 million new skin cancers are diagnosed annually, which is increasing at a rate of about 5% per year. Increased exposure to the sun without skin protection and a decreased ozone layer are regarded as the main causes of this increase—a problem estimated to be costing over 1 billion Euros in annual medical treatment expenses. Over 80% of skin cancers occur in the head and neck regions with 50% occurring in patients over 60 years of age. It is expected that a portion of the senior population will double in year 2025 compared to the present demographics. Because of the growing incidence of skin cancer and increasing share of the senior population in the overall demographics, much focus has been placed on cancer treatments and cancer treatment logistics.

Non-proliferative cancers, which are defined by substantially superficial lesions, may be treated in different ways. In one example, non-proliferative cancers may be treated surgically. Surgery, however, may have certain drawbacks, such as, for example, long waiting lists, complications related to post-treatment care, and risk of infection. As an alternative to surgery, patients may undergo irradiation using electrons of soft X-rays. Irradiation may have an advantage of being non-invasive and of a short duration (a treatment session may be as short as 2 to 4 minutes). It will be appreciated that usually the integral treatments using radiotherapeutic techniques may require a number of sessions.

Recently, the use of a portable X-ray unit has been suggested, which may be used inside a hospital radiotherapy department. An embodiment of such portable unit is described in U.S. Pat. No. 5,425,069. Existing X-ray unit devices include a counterweighted articulated X-ray tube support arm. The arm is used to position the X-ray tube in space without moving a supporting carriage. The articulated arm is slidable along a mast rigidly connected to the support carriage. The known articulated X-ray arm includes a plurality of pivotable support appendages allowing an X-ray tube to be moved in planar motion substantially horizontal to the ground supporting the carriage. Existing X-ray units may have certain drawbacks. For example, those units may be bulky and may support a limited number of orientations of the X-ray tube in space. Such limited number of orientations may not be sufficient to enable a proper alignment of the X-ray beam with respect to a tumor positioned in a patient's skin.

### SUMMARY OF THE INVENTION

It is an object of the disclosure to provide a substantially compact mobile X-ray unit having improved maneuverability of the X-ray applicator. To this end, the mobile X-ray unit of the present disclosure may include a mast associated with a base. An articulated arm may be mechanically coupled to the mast, and may support an X-ray applicator that includes an X-ray tube. The mast may be configured to be displaced relative to the base along a substantially upright axis.

It will be appreciated that the terms ‘mobile’ and ‘portable’ in the context of the present application may be interchanged as these terms equally relate to an easily moved or transported device, for example, a device which may be moved or transported by a single individual.

It will be further appreciated that the articulated arm may be provided with a rotational joint and a ball joint. The rotational joint and the ball joint may be disposed at opposing end portions, or near the end portions, of the articulated arm. Those skilled in the art would readily appreciate that a position of the rotational joint and the ball joint along the arm may be determined at the time of manufacture.

It will be further appreciated that the substantially upright axis extends in a substantially vertical direction, which is generally upright. However, it will be further appreciated that the terms ‘generally upright’ or ‘substantially vertical’ may relate to a direction substantially perpendicular (+−20 degrees) to a plane of the surface on which the mobile X-ray unit is sitting.

By allowing the mast of the mobile X-ray unit to travel along the substantially upright axis and by providing the articulated arm with substantial degrees of freedom, the X-ray applicator may be positioned in almost any position in space. It will be appreciated that the X-ray applicator may have a preferred alignment in space that corresponds to an alignment which has a higher probability of being used. The rotatable articulated arm may be substantial and sufficiently robust to hold the X-ray tube at an angled displacement with respect to the upright direction.

In various embodiments of the present disclosure, the articulated arm may be coupled to the mast using the rotational joint. The articulated arm may be coupled to the X-ray applicator using the ball joint. This arrangement may improve stability of the X-ray applicator in space and enable maneuverability of the X-ray applicator.

The X-ray applicator may be stored in a compact (non-protruding) retracted position in which the articulated arm is disposed adjacent the mast. More details on this embodiment will be discussed with reference to FIGS. 1a and 1b.

The ball joint may be configured to provide both ease of operation and mechanical stability. In one embodiment, the ball joint may be provided with a dedicated brake unit for holding the ball joint in position when the X-ray applicator is in a treatment position. This feature may be particularly advantageous for use when the X-ray applicator is at an angle of more than 45 degrees with respect to a vertical direction. It will be appreciated that, due to a combination of the rotation of the articulated arm with respect to the mast and the displacement of the segments with respect to each other, angulations of the X-ray applicator at degrees larger than 45 degrees may not be necessary because the patient may be easily positioned under the X-ray unit with the target region being substantially horizontal.

In order to improve maneuverability of the X-ray applicator, the mast may be arranged to cooperate with a sliding carriage so as to displace the mast in an upward and/or a downward direction.

It may be advantageous to provide a sliding carriage so as to provide smooth displacement of the mast with respect to the base of the mobile X-ray unit. The sliding carriage may be arranged to decrease a velocity of the mast when it approaches the extreme positions. For example, resilient bodies, like a spring or an elastic cushion, may be provided to moderate the velocity of the mast. This feature may be advantageous as undesirable mechanical shocks could possibly displace parts of the X-ray applicator and/or X-ray tube. Accordingly, the sliding carriage may avoid and/or mitigate such problems.

In some embodiments, the X-ray unit may further include a counterbalance for the mast. The counterbalance may include one or more clock springs. The clock springs may improve the mechanical stability of the X-ray unit when the mast is moved to its uppermost and/or lowermost stand positions. Known clock springs may be utilized and, accordingly, will not be described in here detail.

In various embodiments, sensors may be coupled to the rotational joint and/or the ball joint and may be configured to detect a position of the joint in space.

It may be advantageous to provide the rotational joint and/or the ball joint with sensors so as to record the position of each of the joints in space. This may be useful for recurrent treatments, when the patient undergoes a plurality of repeated irradiations. In particular, the joint location data may enable the X-ray tube to be positioned at the same location relative to the patient at each session. It will be appreciated that for such procedures a stationary base may be required. Alternatively, the base may have a pre-determined position when moved towards the irradiation location.

The X-ray unit may further include a processor for controlling the operation of the X-ray unit, including the settings of the X-ray tube. The sensors may configured to communicate the position of rotational joint and/or the ball joint to the processor. The processor may be further configured to store the joint locations in a patient file and to retrieve the stored joint locations at a later session.

In various embodiments, the X-ray applicator may be counter-balanced to a preferred axial alignment along the vertical direction. The X-ray tube may be used most frequently when aligned along a generally vertical axis, or with a small deviation from it (less than 20 degrees). Accordingly, it may be advantageous to provide a weight-balanced mechanical configuration, including an articulated arm having two segments, so that substantially no net force is exerted on the mast in a radial direction. Such a configuration may improve the mechanical stability of the X-ray unit as a whole. In addition, the X-ray unit may be securely maneuvered by pulling on the X-ray applicator.

In various embodiments, the applicator may be connected to a segment of the articulated arm in a region near a distal portion of the X-ray applicator. Such a connection between the articulated arm and the X-ray applicator may improve the angular maneuverability of the X-ray applicator. In some embodiments, the X-ray applicator may additionally include a window for emitting the X-rays at its distal end portion.

Another embodiment of the present disclosure is directed to a method for manufacturing a mobile X-ray unit. The mobile X-ray unit may include a base, a mast associated with the base, and an articulated arm coupled to the mast. The articulated arm may be configured to support an X-ray applicator having an X-ray tube. The method may include displacing the mast relative to the base in an upward direction. The method may further include providing the articulated arm with a ball joint at one end portion and a rotating joint at an opposing end portion. The method may further include coupling the X-ray applicator to the articulated arm.

Another embodiment of the present disclosure is directed to a mobile medical care unit. By way of example, the mobile medical care unit may be a bed, a chair, a trolley, a cart, a galley, or a treatment unit. The mobile medical unit may include at least three wheels interconnected by a flexible frame. The flexible frame may be configured to allow automatic adjustment of the height of each wheel when contacting a ground surface. For example, the frame may comprise one or more branches which may be provided with a weak region that may deform under application of the weight of the mobile medical care unit as the mobile medical care unit is moved over the ground. In particular, the frame may comprise flexible regions, adapted to be resilient and/or bendable under application of the weight of the medical care unit. In one embodiment, the flexible frame comprises one or more branches having from one or more segments coupled by a spring. Thus, the flexible frame may have an advantage when the mobile medical care unit is transported over an uneven floor, or a floor having irregularities, such as bumps. It will be appreciated that for many applications, it may be desirable that the mobile medical care unit does not change its spatial orientation even when being transported over an irregular surface. For example, it may be desirable to keep laboratory trays, beds, neonatal beds, and food supply trays, in a substantially constant orientation when transported.

In one embodiment, the mobile medical care unit may be a mobile X-ray unit. It may be advantageous to provide the mobile X-ray unit of the present disclosure with wheels that are supported by a flexible frame. For example, the disclosed mobile X-ray unit may be provided in a vehicle and transported to different treatment locations (i.e., provided as a mobile clinic). In certain circumstances, a treatment may be carried out in inferior conditions. Even treatment in open air is possible. By providing the mobile X-ray unit with a possibility of self-adaptation to the surface irregularities, the adjustment of the X-ray applicator may be carried out in substantially the same way as if the treatment is carried out in a doctor's office. In addition, by ensuring that the X-ray applicator is located in substantially the same orientation when stored, the doctor may go through substantially the same routine for positioning the X-ray applicator for treatment as in the doctor's office. Accordingly, human errors due to a complex three-dimensional handling of the X-ray applicator may be avoided.

These and other aspects of the disclosure will be discussed with reference to drawings wherein like reference numerals or signs relate to like elements. It will be appreciated that the drawings are presented for illustration purposes only and may not be used for limiting the scope of the appended claims.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the invention and together with the description, serve to explain the principles of the invention.

### BRIEF DESCRIPTION OF THE DRAWINGS

FIG. 1a presents a perspective view of a mobile X-ray unit according to embodiments of the present disclosure.

FIG. 1b presents a partial perspective view of the mobile X-ray unit, illustrating displacement of an X-ray applicator of the mobile X-ray unit relative to a base of the mobile X-ray unit, according to embodiments of the present disclosure.

FIG. 2 presents a diagrammatic representation of the mobile X-ray unit, according to embodiments of the present disclosure.

FIG. 3 presents an end view of an X-ray tube, according to embodiments of the present disclosure.

FIG. 3, E-E presents a cross-section along line VII-E of the X-ray tube of FIG. 3, according to embodiments of the present disclosure.

FIG. 3, F-F presents a cross-section along line VII-F of the X-ray tube of FIG. 3, according to embodiments of the present disclosure.

FIG. 4 presents is a partial perspective view of the articulated arm according to an aspect of the invention.

FIG. 5 presents a partial perspective view of a medical care unit, such as a mobile X-ray unit, according embodiments of the present disclosure.

FIG. 6 presents an enlarged view of a flexible frame of the medical care unit, according to embodiments of the present disclosure.

FIG. 7 presents another view of the flexible frame shown in FIG. 6, according to embodiments of the present disclosure.

### DETAILED DESCRIPTION OF THE DRAWINGS

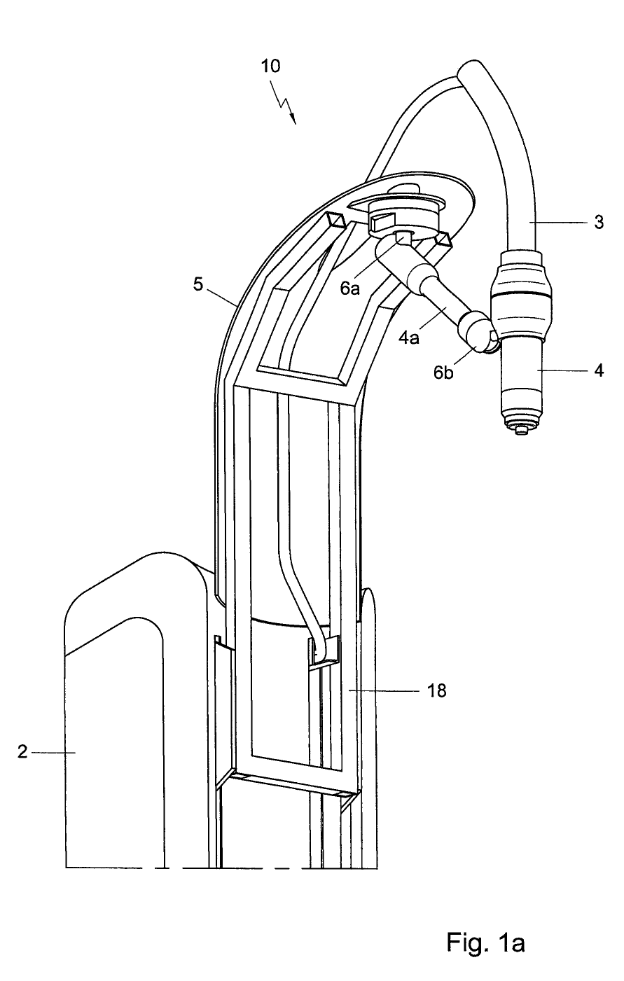

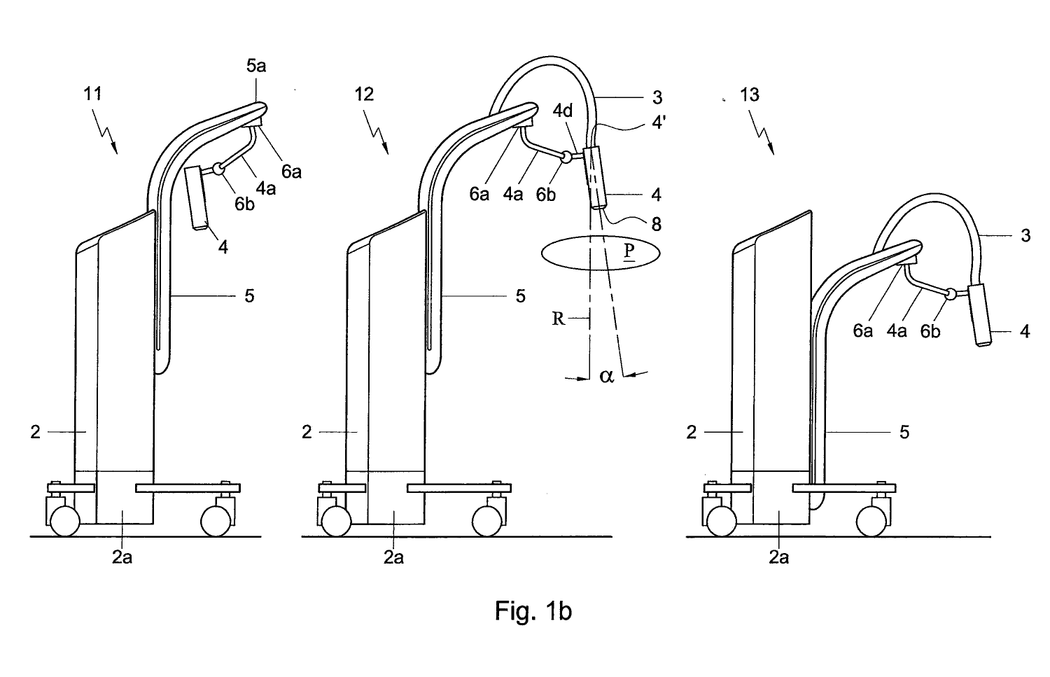

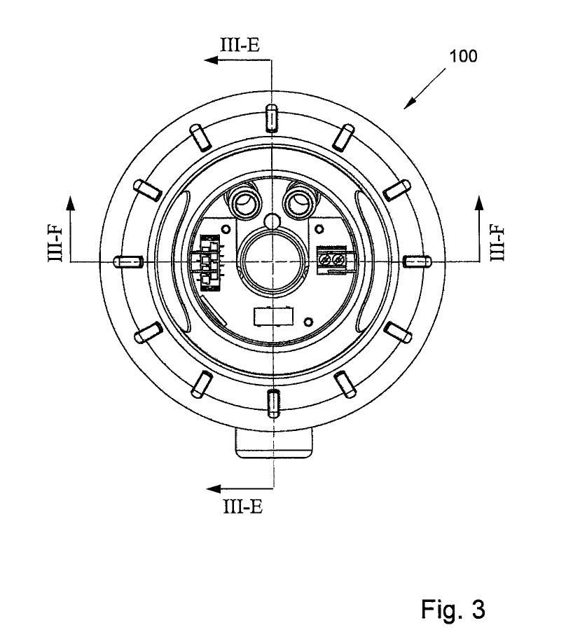

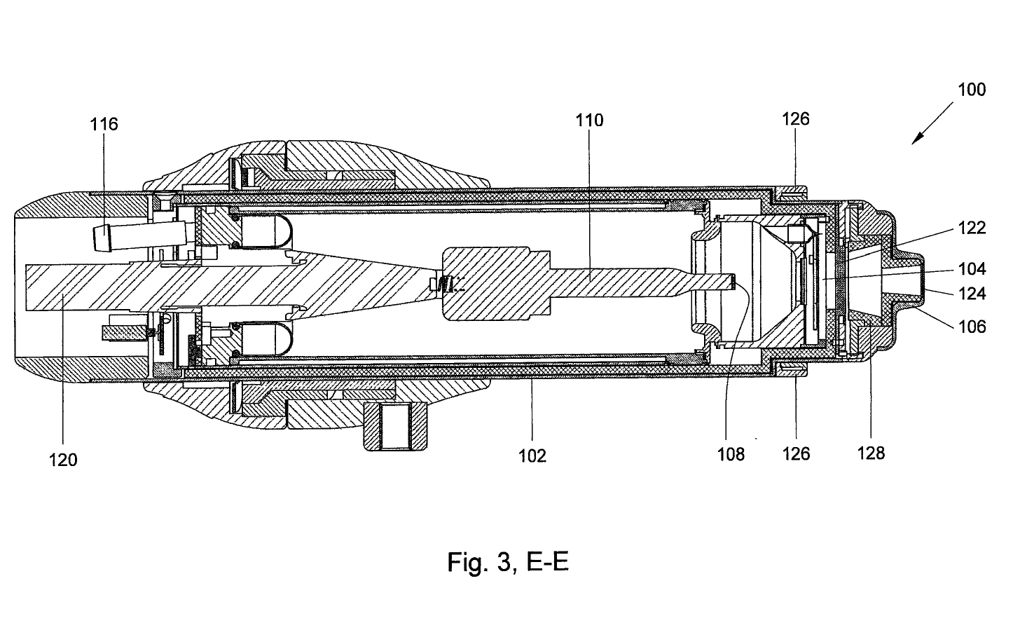

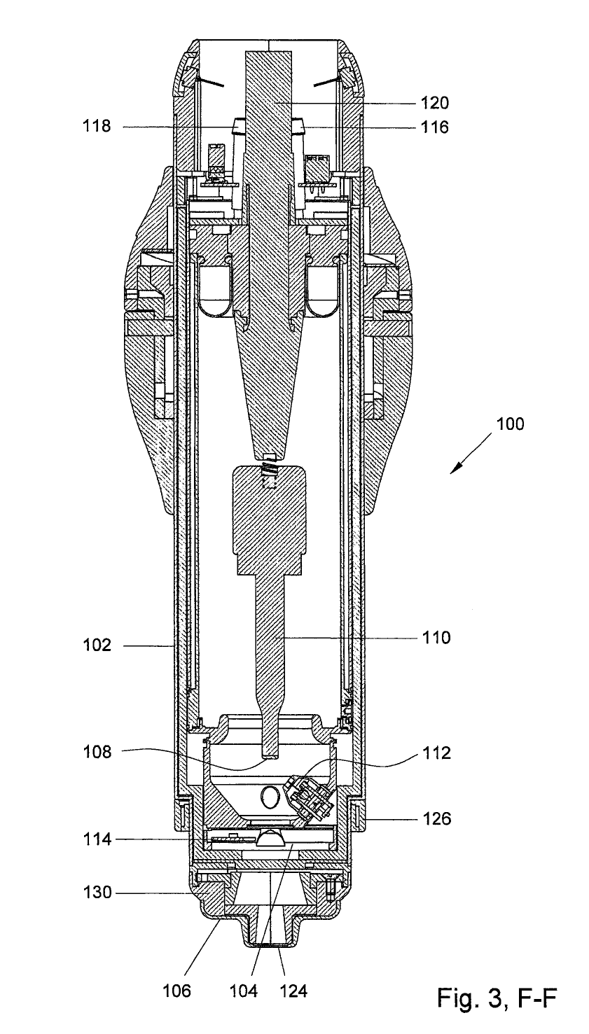

FIG. 1a presents a perspective view of a mobile X-ray unit. The mobile X-ray unit 10 may include a base 2 having at least a power supply unit, a cooling system, and a control unit for controlling the operation of an X-ray applicator 4. The X-ray applicator 4 includes an X-ray tube (FIG. 3) accommodated in an outer housing (FIG. 3). The X-ray applicator 4 may be electrically connected to the appropriate controls in the base using flexible cables 3 to the suitable controls, which may be at least partially received in a displaceable mast 5. The applicator 4 may be supported by an articulated displaceable arm 4a, which may include a rotatable joint 6a that is connected to the mast 5. The articulated arm 4 may further include a ball joint 6b that is connected to the X-ray applicator 4, and may be configured to alter the angulation of the X-ray applicator 4 in space.

Because the articulated arm 4a is connected to the displaceable mast 5, a range of vertical positions of the X-ray applicator 4 in space may be possible. In some embodiments, the displaceable mast 5 may be provided with a handle (not shown) enabling easy manipulation thereof.

The displaceable mast 5 may be guided along suitable rails using a slidable carriage 18 for enabling a substantially smooth and shock-free displacement thereof. In some embodiments, the sliding carriage 18 may be configured to decrease a velocity of the mast when it approaches the extreme positions (i.e., an uppermost position and/or an lowermost position). In these embodiments, resilient bodies, like a spring or an elastic cushion may be provided to moderate and/or limit the velocity of the mast. This feature may be advantageous since undesirable mechanical shock could possibly cause misalignment of parts of the X-ray applicator and/or X-ray tube. In certain embodiments, the X-ray unit 10 may include a counterbalance (not shown) for the mast 5. The counterbalance may include one or more clock springs. This may be improve the mechanical stability of the X-ray unit 10 when the mast 5 is moved to the uppermost end of its travel position. Known clock springs may be utilized and, accordingly, will not be described in here detail.

In some embodiments, the base 2 may be provided with additional functionality, such as a display (not shown) for displaying user information. The display may be arranged as a touch-sensitive screen for enabling suitable data input into the system.

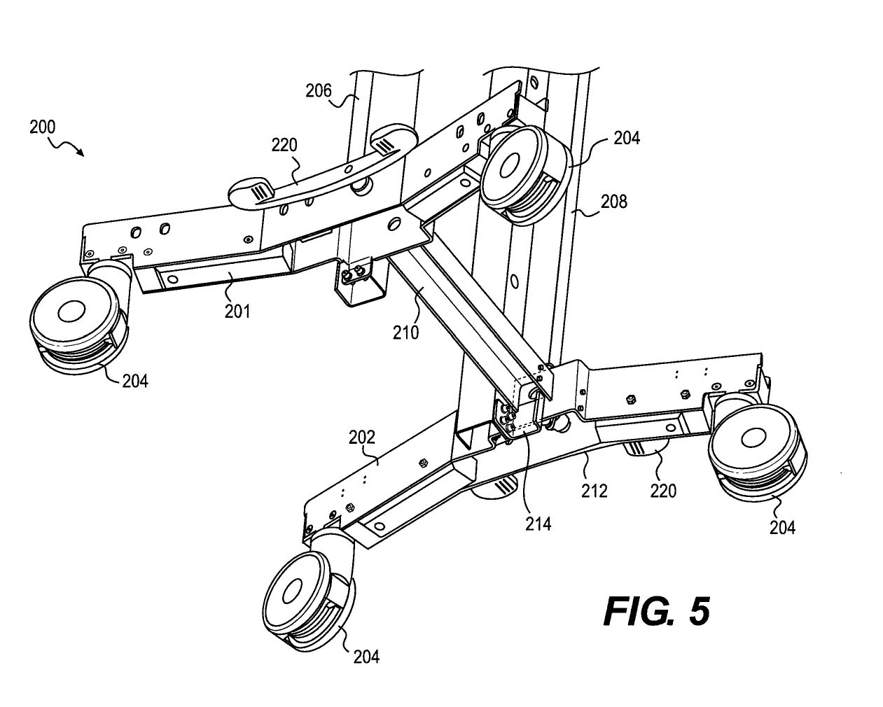

The mobile X-ray unit 10, according to the present disclosure, may include a set of wheels supported by a frame (FIGS. 5-7). In some embodiments, the wheels are interconnected by a deformable frame which ensures that all wheels make contact with an underlying surface, such as a floor or ground, even if such surface is not completely flat.

For example, the frame may comprise one or more branches working together or individually for supporting the wheels of the base. When the weight of the mobile X-ray unit is applied the branch shall be deformed allowing the full contact of all of the wheels with the ground.

In one embodiment, the frame may comprise flexible regions, adapted to be resilient and/or bendable under application of the weight of the mobile X-ray unit. A spring or other resilient mechanism, such as rubber, may constitute the flexible regions of the frame. The flexible frame is discussed with reference to FIGS. 5-7.

FIG. 1b illustrates the displacement of the X-ray applicator 4 of the X-ray unit 10. It should be understood that mobile X-ray unit 10 may be configured so as to support a broad range of translational and rotational movements of the X-ray applicator 4.

In view 11, the X-ray applicator 4 is in a retracted position. The X-ray applicator 4 may be placed in the retracted position by rotating X-ray applicator 4 relative to the mast 5. In particular, the articulated arm 4a may be rotated and bent in the direction of the base 2 and positioned under the mast 5 using the rotational joint 6a. Ball joint 6b may also be used to position the X-ray applicator 4 in the retracted position.

In some embodiments, the mast 5 may have a curved body. In particular, a portion of mast 5 having an X-ray applicator mount 5a may be curved and have length sufficient to receive the X-ray applicator 4 when the X-ray applicator 4 is in the retracted position. It will be appreciated that in the retracted position, the X-ray applicator 4, may not laterally protrude beyond the body of the mast 5. Those skilled in the art will appreciate that the exact geometry of the mast 5 may be dependent on the absolute dimensions of the X-ray applicator 4 and the length of the articulated arm 4a.

The retracted position may be suitable for transport of the mobile X-ray unit 10 towards a booth and/or for maneuvering the X-ray unit 10 around the patient. For ensuring stability of the mobile X-ray unit 10 during maneuvering thereof, a load block 2a may be provided for lowering the point of gravity of the X-ray unit 10.

In view 12, the X-ray applicator 4 may be in an extended position having an X-ray exit surface 8 oriented towards a patient P. In order to suitably position the X-ray applicator 4 with respect to the patient P, the mast 5 may be moved to an intermediate position located between the lowest position and the highest position of the mast 5.

The articulated arm 4a may be used for suitably rotating the X-ray applicator 4 about a rotation axis. The rotational joint 6a may be used to coarsely position the articulated arm 4a and the ball joint 6b may be used to displace the X-ray applicator 4 about a rotation axis. In some embodiments, the rotation axis R may be selected to coincide with a direction of emanation of the X-ray beam from the exit surface 8 for a vertically oriented X-ray applicator 4. Because the X-ray applicator 4 is fixed to a segment 4d at its distal portion 4′, rotation about the rotation axis R is simplified. In some embodiments, it may be desired to record an angle between the rotation axis R and the axis of the X-ray tube. For this purpose, the rotational joint 6a and ball joint 6b may be provided with suitable sensors for automatically detecting the position of each of the joints.

In view 13, the X-ray applicator 4 may be in a lowered position. For this purpose the mast 5 may be in its lowest position and the arm 4a may be used for orienting the X-ray applicator 4 in a desirable way. In order to avoid mechanical shock when positioning the mast 5 in its lowest position, the sliding carriage 18 guiding the displacement of the mast 5 may be provided with a resilient mechanism. It is also contemplated that the displacement of the mast 5 may be carried out automatically using drive motors. In those embodiments, a processor of the mobile X-ray unit 10 may be arranged to automatically decrease the velocity of the mast 5, when the mast 5 approaches either the uppermost and/or lowermost positions.

It will be appreciated that although in the preferred embodiment the articulated arm 4a comprises a single segment, it is also possible that the articulated arm 4a may be provided with two or more segments interconnected by respective pivots.

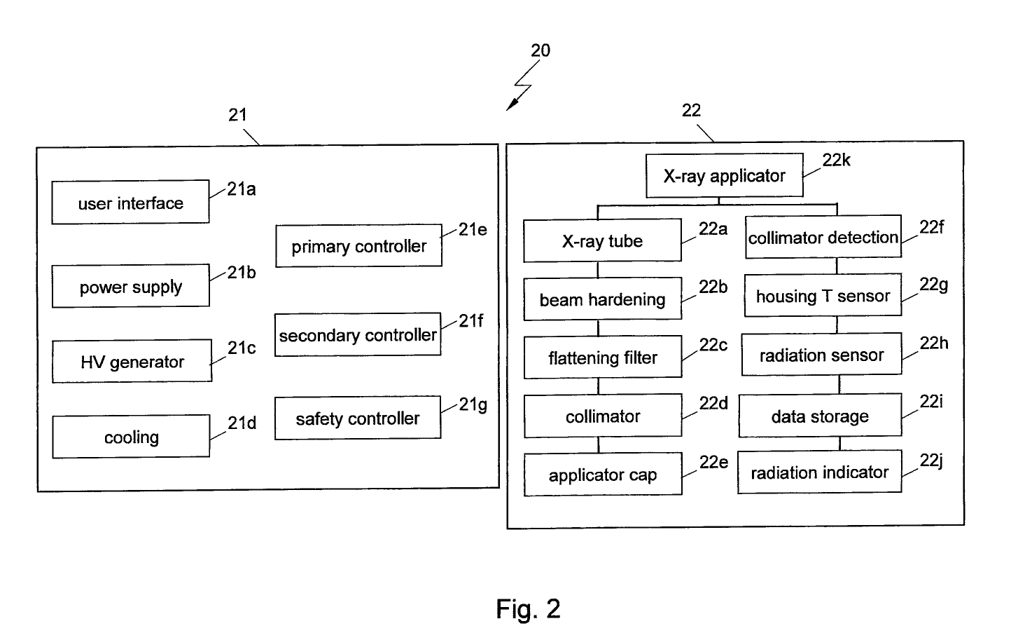

FIG. 2 is a diagrammatic representation of the mobile X-ray unit 10. The mobile X-ray unit 10 includes a high voltage supply, preferably adapted to generate 50-75 kV X-rays in a suitable X-ray tube, a cooling system for cooling the X-ray tube during use, and a control system for controlling electronic and electric parameters of sub-units of the X-ray unit during use. View 20 diagrammatically depicts main units of the control system 21 and of the X-ray applicator 22.

The control system 21 includes a hard wired user interface 21a for enabling switching on and switching off of the high voltage supply 21b. In some embodiments, the high voltage supply 21b comprises a high voltage generator 21c with improved ramp-up and ramp-down characteristics. The high voltage supply is preferably operable for delivering power of about 200 W in use. In some embodiments, the ramp-up time may be of the order of 100 ms. The hard wired interface 21a, may also be arranged to automatically switch on the cooling system 21d when the high voltage generator is switched on. In addition, the control system 21 may include a primary controller 21e arranged for controlling the dose delivery from the X-ray applicator 22 in use. The primary controller 21e may be provided with a primary counter adapted to register time lapsed after the X-ray radiation is initiated. The primary counter may then automatically switch off the high voltage supply to the X-ray tube 22a in the event a pre-determined dose is reached. It will be appreciated that the pre-determined dose is at least dependent on the energy of the X-rays and the dose rate, which may be calibrated in advance. Where calibrated data is made available to the primary controller 21e, adequate primary dose delivery control may be achieved. In some embodiments, a secondary controller 21f may be provided for enabling an independent loop of dose delivery control. The secondary controller 21f may be connected to a dose meter accommodated inside the X-ray applicator 22 in the X-ray field before the collimator 22d. Accordingly, the dose meter may provide real-time data on actual dose delivery taking into account dose variation during ramp up and ramp down of the high voltage source. Still preferably, the control system 21 may include a safety controller 21g adapted to compare readings from the primary controller 21e and the secondary controller 21g for switching off the high voltage generator 21c after a desired dose is delivered. Additionally and/or alternatively, the safety controller 21g may be wired to guard emergency stop, door interlock, and a generator interlock.

In an exemplary embodiment, the X-ray applicator 22 may include an X-ray tube 22a housed in an outer housing (shielding) 22k. The X-ray tube 22a may have a target-collimator distance of between 4 and 10 cm, and preferably 5 and 6 cm. The X-ray applicator 22 may further comprise a beam hardening filter 22b selected to intercept low-energy radiation and a beam flattening filter 22c, designed to intercept portions of X-ray radiation for generating a substantially flat beam profile near the exit surface of the X-ray applicator 22. Further, the X-ray applicator 22 may comprise one or more collimators 22d arranged to define treatment beam geometry. Preferably a set of collimators 22d may be used having, for example, diameters of 1, 1.5, 2, 2.5, 3, 3.5, 4, 4.5, and 5 cm. It will be appreciated that although circular collimators are discussed, collimators of any shape, such as square, elliptic, or custom made collimators are possible. It may be advantageous to have an X-ray applicator 22 with automatic collimator detection means 22f adapted to automatically signal which collimator is being used. In some embodiments, resistive sensing may be used to identify which collimater 22d is being used. In particular, each collimator may be provided with at least a couple of projections for bridging a resistive path provided in a collimator receptacle. The resulting electrical resistance of the receptacle constitutes a signal representative of a collimator being used.

The X-ray applicator 22 may also include a built-in temperature sensor 22g adapted to signal temperature of the X-ray tube 22a and/or its shielding 22k. The signal from the temperature sensor 22g may be received by the control system 21 which may carry out the analysis thereof. Should the measured temperature be elevated beyond an allowable level, an alarm signal may be generated. Optionally, a shut-off signal to the high voltage generator may be provided. The X-ray applicator 22 may further comprises a radiation sensor 22h arranged inside the outer housing 22k for detecting X-ray radiation which may be delivered by the X-ray tube 22a. Preferably, for safety reasons the X-ray applicator 22 may include a non-volatile data storage 22i arranged for recording operational parameters at least of the X-ray tube 22a. Further, to enhance radiation safety, the X-ray applicator 22 may be provided with a radiation indicator 22j arranged for providing a visual and/or an audio output to the user and/or the patient regarding ON/OFF condition of the X-ray tube 22a. It will be appreciated that the radiation indicator 22j may comprise a plurality of signaling devices. In one embodiment, at least one signaling device, for example a light emitting diode (LED), is associated with the X-ray applicator 22 and provided on the X-ray applicator 22. It is understood, however, that the signaling devices may be positioned at any other location on the mobile X-ray unit.

The processor 21e may be adapted to store the values automatically provided by the joint sensors for future use. In addition, when the displacement of the mast 5 is carried out automatically, the processor 21e may control the driving motors to avoid mechanical shocks when the mast 5 arrives at an end position along its displacement trajectory.

FIGS. 3, 3E-E, and 3F-F, illustrate various views of the X-ray tube. The X-ray tube 100 has a body 102 enclosing at one end an end window 104 through which the X-rays exit the X-ray tube 100, see FIG. 3 cross-section E-E. The end window 104 is made from a thin sheet of Beryllium metal. An applicator cap 106 may be positioned over the end window 104 so as to covering the end window 104 and protect end window 104. Applicator cap 106 may be made from a plastic material. The applicator cap may be manufactured from PVDF (polyvinylidene fluoride) and may have a thickness of about 0.4-0.7 mm, and preferably 0.6 mm, across the window portion. Alternatively, the applicator cap 106 may be manufactured from PPSU (polyphenylsulfone) and have a thickness of about 0.3-0.6 mm, and preferably 0.5 mm, across the window portion.

In the tube body 102, a target 108 is located at a range between 4 and 10 cm from the collimator 130, and preferably between 5 and 6 cm from the collimator 130 (see FIG. 3, cross-section F-F). It will be appreciated that this distance is measured between the outer surface of the target 108 and a midplane of the collimator 130. The target 108 may be made from Tungsten metal to provide the desired X-ray spectrum. The tungsten tip of the target 108 may be mounted on a large anode assembly 110 which also serves to conduct away the heat created from the generation of the X-rays in the target 108. Most of the anode assembly 110 is made from copper. The cathode 112 (see FIG. 3, cross-section F-F) may be located slightly off-axis near the end window 104. Electrons emitted from the cathode are accelerated across the gap by the potential difference between the cathode and anode, in this case set at about 70 kV, to the target 108 where the impact causes the generation of X-rays in a known manner. X-rays emitted from the target 108 pass through a beam hardening filter 122 before passing through a collimator 130 and an exit surface 124 on the applicator cap 106. The collimator 130 may be housed in a suitable collimator receptacle 128.

The anode assembly 110 may be mounted in the body 102 and electrically insulated. One of a number of known techniques and materials can be used to provide the desired level of insulation between the anode assembly 110 and the body 102.

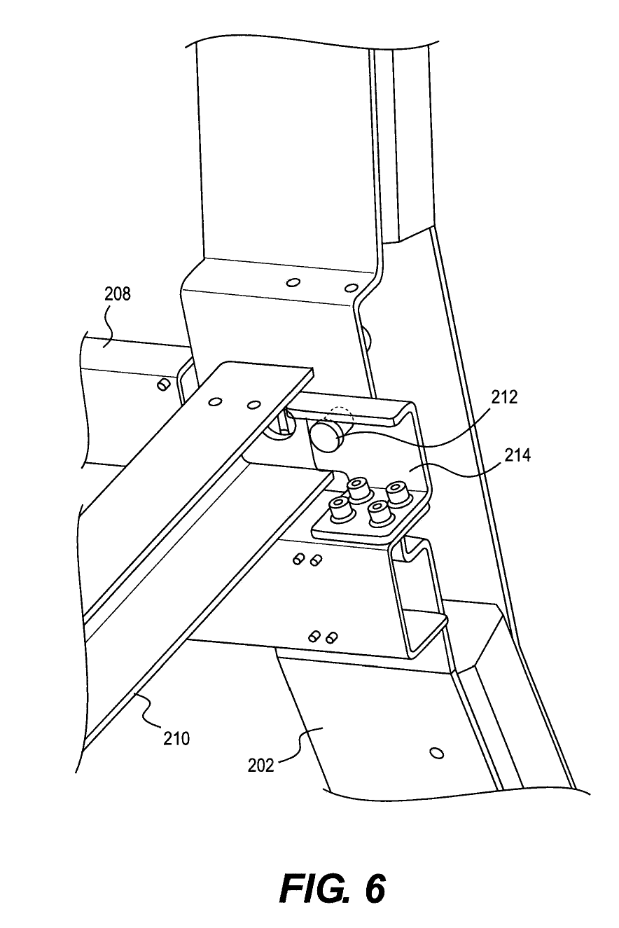

As is well known in the art, the production of X-rays generates large amounts of heat waste. Accordingly, it may be necessary to cool the X-ray tube 100 in order to maintain it at a safe temperature. Various cooling mechanisms are known and used in the art. In one embodiment, the X-ray tube 100 is cooled by cooled water forced around the anode region. Cooled water may enter the back of the tube by a first conduit 116 and leaves by a second conduit 118 (see FIG. 6, cross-section F-F). The water cooling circuit may be a closed loop circuit, with the water leaving the tube assembly 105 to be cooled by a remote cooler (not shown) before returning to the X-ray tube 100. It is contemplated that oil or another liquid may be used as the cooling medium. It is also known that a pressurized gas may be used as an effective coolant in some applications.

As is known in the art, X-rays are generated and emitted in all directions, however the body 102 of the X-ray tube 100 and other internal components will tend to reduce the amount of radiation emitted from the body 102 of the X-ray tube 100 to a minimum, with most of the radiation emitted from the end window 104. The thickness of the shielding provided by the body 102 may be designed so that it provides at least the minimum level of shielding required for safe use by the operator.

A high voltage cable assembly 120 may be connected to the anode assembly 110. The high voltage cable assembly 120 may be connected to flexible cable means (not shown) which in turn may be connected to a high voltage power supply.

A radiation detector 114 may be placed outside the path of the X-ray beam emitted from the target 108 and passing through the end window 104. This detector may be any known form of a radiation detector. In one embodiment, the radiation detector may be a hardened semi-conductor connected to an amplifier. The radiation detector 114 may detect when the tube 102 is working and emitting X-ray energy. Output from the detector 114 may connected to a control unit, and the output signals from the detector 114 may be used to provide an optical indication to a user of whether the tube is operating or not. By this means an X-ray detector 114 may be provided which may be used to detect if the X-ray tube is on or off.

With further calibration of the radiation detector 114, it may be possible to determine and calculate the X-ray dose administered to the patient during the treatment. Thus, it may be possible to have a real time dosimetry measurement system, in which the precise amount of radiation dose administered can be determined. Once the dose rate is known, a treatment plan can be modified during treatment. This is advantageous because it enables a very accurate and carefully controlled dose of X-rays to be administered.

In order to enable the X-ray tube 100 to be placed accurately over a tumour, a tumour illumination device may be is used. The tumour illumination device may include a plurality of lights 126 placed around the circumference of the X-ray tube 100 near the end window 104. When in use, the lights shine onto the skin of the patient. Since the lights 126 are positioned around the circumference of the tube body 102, at a short distance from the end of the X-ray tube 100 they create a circle of light with a sharp cut off of the inner part of the circle. In this way, the position of the lights on the tube body 102 may create a shadow. This shadow circle may be used to indicate the region which will be subject to irradiation when the X-ray tube 100 is turned on. It should be appreciated the area within the circle may not be completely dark; and that the ambient light may be able to enter the shadow region.

In some embodiments, the lights 126 are white LEDs which can be bright enough to clearly illuminate the target region but do not generate a large amount of heat. The lack of heat generation is important because the lights will be in close proximity to the skin of the patient, and so it is important to minimize the risk of burning and/or damaging the skin. Other colours of LEDs may be used. Alternatively, other light sources may be used, such as known filament lamps or even a remote light source connected to the ring by fibre optic cables.

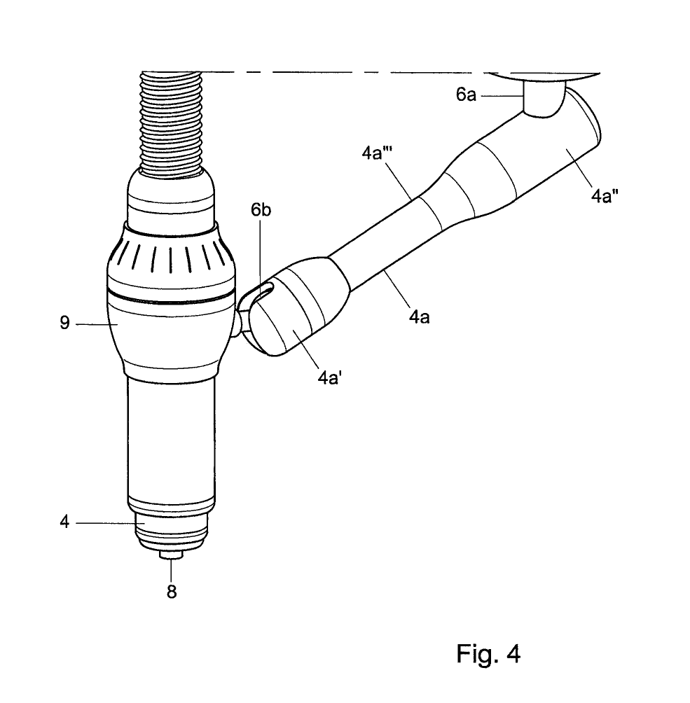

FIG. 4 presents a partial perspective view of the articulated arm 4a, according to an aspect of the present disclosure. As illustrated in FIG. 4, the articulated arm may include a rotation joint 6a and a ball joint 6b. In one embodiment, the end portions 4a′, 4a″ of the articulated arm 4a may be thickened, wherein the intermediate portion 4a′″ may be provided with a diameter convenient to be handled by a human hand. In some embodiments, the diameter of the intermediate portion 4a′″ of the articulated arm is in the range of 4-7 cm.

The ball joint 6b may be provided at an end 4a′ of the articulated arm 4a and the rotational joint 6a may be provided at an end 4a″ of the articulated arm 4a. It should be understood, however, that the ball joint 6b and/or the rotational joint 6a (as shown) may be provided at any location on articulated arm 4a include positions near the ends 4a′, 4a″ of the articulated arm 4a.

The X-ray applicator 4 may have an exit window 8 for passing the X-rays generated by an internal X-ray tube, and may also include a rotatable sleeve 9, for allowing fine adjustment of a downward position of the X-ray tube when its position is set using the articulated arm 4a. In some embodiments, the rotatable sleeve 9 may be adapted to adjust an axial translation of the X-ray applicator 4 by way of, for example, a screw mechanism. It will be understood that any other suitable mechanism for enabling the axial translation of the X-ray applicator may 4 be used including, but not limited to, a telescopic mechanism.

FIG. 5 presents a partial perspective view of an exemplary medical care unit. In particular, FIG. 5 illustrates a partial perspective view of a mobile X-ray unit constructed on a rolling chassis 200. The chassis 200 may be in the shape of an H section. In some embodiments, the legs of the H section are splayed and extend slightly outwards to provide increased stability. The chassis 200 may have four wheels 204 which may be independently rotatable, and can be used to manoeuvre the mobile X-ray unit into a desired position.

The chassis 200 may also be provided with a braking mechanism, which may be operated by a pedal. Twin pedals 220 may be provided, one on each side of the chassis 200. The pedals 220 may be connected by a shaft, thereby ensuring that only one pedal 220 needs to be operated to brake the chassis 200 against movement. The braking mechanism may be arranged to brake diametrically opposed wheels. Other braking mechanisms may be contemplated.

In one embodiment, the chassis legs 201, 202 may be metal channels or beams. The two legs 201 and 202, may be joined by a cross-member 210. The cross member 210 may be of the C shaped cross-section, and may be secured at or near its ends to the legs 201 and 202 by bolts, welding, or nay other method known in the art. It is contemplated that legs 201, 202, and cross-member 210 may have any other shape, size, and/or configuration.

In one embodiment, the legs 201, 202 and cross-member 210 are made from pressed metal parts, however, it is contemplated that legs 201, 202 and cross-member 210 may be formed from any other known material. It is contemplated that the rolling part of the chassis 200 could also be formed from a molded plastic material or in cases requiring higher strength, load carrying characteristics or rigidity, they could be made from cast metal structures.

A first vertical chassis member 206 may be securely attached to a first of the legs 201 and may extend upwardly there from. Connected to the second leg 202 is a second vertically extending chassis member 208. Vertical chassis members 206 and 208 are securely connected together by any known method. The operational equipment forming the mobile X-ray unit such as, for example, the high voltage power supply, the cooling system for the X-ray tube and the control system, may be mounted on the vertical chassis members 206, 208. In addition, the articulated arm (not shown) may be mounted on vertical members 206, 208. This embodiment has an advantage in that the vertical chassis members do not need to be vertical but can be upwardly extending at any angle that is convenient and appropriate for the mounting of any ancillary fittings or equipment.

The first chassis leg 201 may be firmly connected to the vertical chassis member 206 by means of bolts, which facilitate assembly of the chassis. However, other known means of securely fixing two components together, such as by welds can be used. The second vertical chassis member 208 may be connected to the second leg 202 by means of a bearing structure. Second vertical chassis member 208 may be firmly secured to a mounting bracket 214 by means of bolts, welds, or any other known securing structures. The mounting bracket 214 may be provided with a bearing support means which co-operates with a corresponding bearing means in the second leg 202. The bearing is conveniently in the form of a shaft or pin 212. Shaft 212 extends through a bearing support means in the mounting bracket 214 into a co-operating support means in the leg 202. The shaft 212 and co-operating bearing holes enable the second vertical member 208 to rotate about an axis defined as extending along a longitudinal axis of the shaft 212. The bearing support means may be made of any known form of bearing material, such as a relatively soft metal, such as brass, or from a nylon or polyethylene type plastics material.

In operation, the vertical chassis members 206, 208 may be firmly connected together to provide a strong rigid upwardly extending chassis 200 onto which any other components required can be mounted, whilst the rolling part of the chassis may be provided with a flexibility to enable it to accommodate rough or uneven surfaces.

FIG. 6 illustrates a connection between the various components of the flexible frame. It will be appreciated that the construction details for the vertical chassis member 206 may be similar. The shaft 212 includes a rotational axis passing through the centre of the shaft 212 about which the leg 202 may rotate, to allow the rolling part of the chassis 200 to deform and adapt to uneven floors or paths whilst maintaining a relatively stiff upwardly extending chassis portion. The shaft 212 extends through a bearing support means in the mounting bracket 214 into a co-operating support means in the leg 202 (shown in FIG. 5). This construction may allow the legs 201, 202 (shown in FIG. 5) to rotate with respect to one another as they move over (or rest on) uneven surfaces, so as increase the stability of the equipment as a whole.

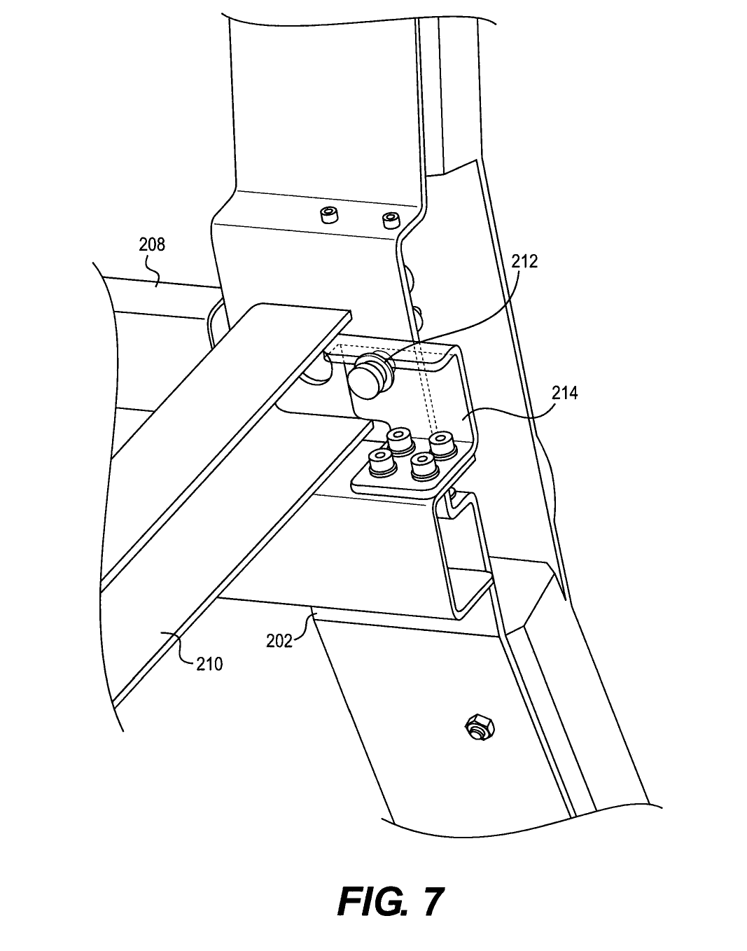

FIG. 7 presents another view of the flexible frame shown in FIG. 9. The leg 202 may be mechanically linked by bearing means 212 through the mounting bracket 214 to the chassis member 208. As described above, the cross member 210 may be attached at or near each of its ends to one of the legs 201, 202. The cross-member 210 may keep the legs in their chosen relative positions when the unit is stationary. However, the legs may be subject to rotational twisting and torque as the chassis 200 moves over uneven ground. The structural strength of the cross member 210 may generate forces to resist the twist of the legs 202 with respect to one another, and may also provide a damping effect to restrict and cushion the relative movement of the legs 202. It will be apparent that the rotational stiffness of the cross-member 210 may be chosen to provide the desired damping effect taking into consideration the weight of the mobile unit and the un-evenness of the ground being traversed.

While specific embodiments have been described above, it will be appreciated that the invention may be practiced otherwise than as described. The descriptions above are intended to be illustrative, not limiting. For example, the X-ray device according to the invention maybe used with the X-ray applicator accommodating an X-ray tube having a side X-ray exit window. Thus, it will be apparent to one skilled in the art that modifications may be made to the invention as described in the foregoing without departing from the scope of the claims set out below.

What is claimed is:

1. A mobile X-ray unit comprising:
a base;
a mast associated with the base;
an articulated arm operably coupled to the base, wherein the arm includes a ball joint and a rotational joint, wherein the arm rotates relative to the mast about the rotational joint; and
an X-ray applicator configured to generate an X-ray beam, wherein the X-ray applicator rotates relative to the mast about the ball joint to allow positioning of the X-ray applicator.

2. The mobile X-ray unit according to claim 1, wherein the mast includes an X-ray applicator mount, and wherein a proximal portion of the X-ray applicator is coupled to the mast at the X-ray applicator mount.

3. The mobile X-ray unit according to claim 1, wherein the mast includes a curved portion.

4. The mobile X-ray unit according to claim 3, wherein the X-ray applicator is positioned under the curved portion in a retracted position.

5. The mobile X-ray unit according to claim 1, wherein the mast is associated with a sliding carriage, and wherein the sliding carriage is configured to move along a vertical axis relative to the base.

6. The mobile X-ray unit according to claim 1, wherein the X-ray applicator is configured to be displaced about a rotational axis that is parallel to a longitudinal axis of the X-ray applicator.

7. The mobile X-ray unit according to claim 2, wherein the X-ray applicator is connected to the arm at an area near a distal portion of the X-ray applicator.

8. A method for operating a mobile X-ray unit comprising a base, a mast associated with the base, and an articulated arm coupled to the mast and supporting an X-ray applicator, the method comprising:
displacing the mast relative to the base; and
rotating the arm to displace the X-ray applicator relative to the mast.

9. The method of claim 8, wherein the articulated arm has a first end portion and a second end portion, and wherein the first end portion includes a ball joint and wherein the second end portion includes a rotating joint.

10. The method according to claim 9, wherein the articulated arm is coupled to the mast by the rotational joint.

11. The method according to claim 9, wherein the articulated arm is coupled to the X-ray applicator by the ball joint.

12. The method according to claim 11, wherein the articulated arm is coupled to the X-ray applicator at an area near a distal portion of the X-ray applicator.

13. The method according to claim 9, further comprising displacing the X-ray applicator at an angle relative to the mast.

14. The method according to claim 9, wherein displacing the mast relative to the base includes displacing the mast along a vertical axis.

15. A mobile X-ray unit comprising:
a base;
a mast associated with the base;
an arm having a first end and a second end, the first end being coupled to the mast and the second end being coupled to an X-ray applicator configured to generate an X-ray beam,
wherein the mast is configured to move relative to the base along a vertical axis, and wherein the articulated arm has a ball joint at the first end and a rotational joint at the second end to displace the X-ray applicator relative to the mast.

16. The mobile X-ray unit according to claim 15, wherein the mast includes an X-ray applicator mount, and wherein a proximal portion of the X-ray applicator is coupled to the mast at the X-ray applicator mount.

17. The mobile X-ray unit according to claim 15, wherein the mast is associated with a sliding carriage, and wherein the sliding carriage is configured to move along the vertical axis.

18. The mobile X-ray unit according to claim 15, wherein the X-ray applicator is configured to rotate about the rotational joint to orient an exit surface of the X-ray applicator in a direction away from the base.

19. The mobile X-ray unit according to claim 15, wherein the X-ray applicator is connected to the arm at an area near a distal portion of the X-ray applicator.

20. The mobile X-ray unit according to claim 15, wherein the X-ray applicator is configured to be displaced about a rotational axis that is parallel to a longitudinal axis of the X-ray applicator.
